(19) United States
(12) Patent Application Publication
(10) Pub. No.: US 2014/0060443 A1
(43) Pub. Date: Mar. 6, 2014

(54) PET FEEDER WITH A RAISED HANDLE

(71) Applicant: Harold Ronald Swift, Quincy, FL (US)

(72) Inventor: Harold Ronald Swift, Quincy, FL (US)

(21) Appl. No.: 13/602,070

(22) Filed: Aug. 31, 2012

(51) Int. Cl. A01K 5/01

(52) U.S. Cl. 119/61.56

(57) ABSTRACT

A pet feeder has a raised handle to prevent a user from having to bend over each time they desire to get or place food and/or water bowls. The pet feeder can include a frame for retaining one or more food and/or water bowls, typically two bowls, side-by-side. Legs can extend from the frame and rubber feet can help prevent the pet feeder from moving along a floor during use.

### BACKGROUND OF THE INVENTION

The present invention relates to pet feeders and, more particularly, to a floor level pet feeder with a raised handle to prevent having to bend over to pick up or put down food and/or water.

Pet feeders and water bowls are used at floor level, or, at most, raised slightly off the floor. Either way, a pet owner has to bend over multiple times a day to feed their pets and add water to their water bowls. Many times, a pet, while feeding or getting water, will move their bowl, requiring repositioning, and requiring further bending. Many pet owners will periodically pick up and wash food and water bowls, again, requiring bending to gather and replace the bowls. This can be difficult for many people, especially the elderly and people with back and knee problems.

As can be seen, there is a need for a pet bowl having a mechanism to allow a user to pick up and place the pet bowls without having to bend over each time.

### SUMMARY OF THE INVENTION

In one aspect of the present invention, a pet feeder comprises a bowl frame adapted to support one or more bowls; an extension rod extending upward from the bowl frame; and a handle disposed on an end of the extension rod. In another aspect of the present invention, a pet feeder comprises a bowl frame adapted to support two bowls therewithin; a mid bar connecting opposite sides of a mid-section of the bowl frame, the mid bar further supporting the bowls; legs extending downward from the bowl frame; an extension rod extending upward from the bowl frame; and a handle disposed on an end of the extension rod.

These and other features, aspects and advantages of the present invention will become better understood with reference to the following drawings, description and claims.

### BRIEF DESCRIPTION OF THE DRAWINGS

FIG. 1 is a perspective view of a pet feeding device, in use, according to an exemplary embodiment of the present invention;

FIG. 2 is a perspective view of the pet feeding device of FIG. 1;

FIG. 3 is a perspective view of the pet feeding device of FIG. 1 with the bowls removed; and

FIG. 4 is a cross-section view taken along line 4-4 of FIG. 2.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a pet feeder with a raised handle to prevent a user from having to bend over each time they desire to get or place food and/or water bowls. The pet feeder can include a frame for retaining one or more food and/or water bowls, typically two bowls, side-by-side. Legs can extend from the frame and rubber feet can help prevent the pet feeder from moving along a floor during use.

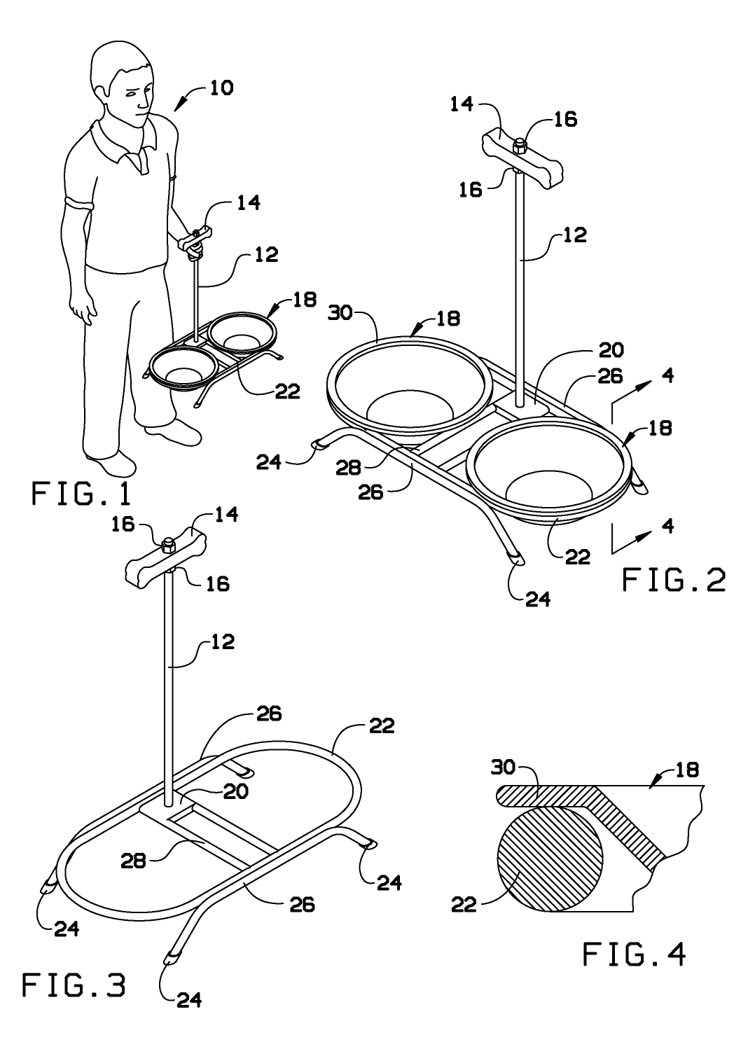

Referring now to FIGS. 1 through 4, a user 10 can grasp a handle 14 at an end of an extension rod 12 to raise and lower food and/or water bowls 18 without the need to bend over.

The pet feeder design can include a bowl frame 22 having a width into which the bowls 18 can be inserted. Typically the pet feeder design includes two bowls 18 that fit into the bowl frame 22, however, the pet feeder design can be configured to hold only a single bowl, or more than two bowls, if desired. For example, the pet feeder design could be configured with three bowls, where a central bowl can be for water and each end bowl can be used for food for feeding two dogs or cats simultaneously.

The bowl frame 22 can generally be in an oval shape, as shown in FIG. 3, for example, but can also be designed in other shapes. Typically, the ends of the bowl frame 22 are shaped to contour to the shape of the bowl 18. As shown in FIG. 4, the bowl frame 22 can support a lip 30 of the bowl 18.

A mid bar 28 can be disposed across a middle width of the bowl frame 22. The mid bar 28 can add support to the bowl frame 22 and also provides a frame for holding the bowls 18.

A rod bracket 20 can be attached to the bowl frame 22, typically also to the mid bar 28, as shown in FIG. 3. The rod bracket 20 can support the extension rod 12. In some embodiments, the extension rod 12 can thread into threads cut into the rod bracket 20. In other embodiments, the extension rod 12 may be non-removably secured to the rod bracket 20, such as by welding.

On the end opposite where the extension rod 12 connects to the rod bracket, the handle 14 can be attached. In some embodiments, the handle 14 can be attached by a nut 16 threaded on the end of the extension rod 12. The handle 14 can be designed in various shapes and colors, such as a bone shape.

Legs 26 can attach to and extend from the bowl frame 22. The legs 26 can include rubber feet 24 to keep the pet feeder from sliding on a surface. Typically, the legs 26 can extend from four opposite corners of the bowl frame 22. The legs 26 can be formed in various heights. In some embodiments, the legs 26 can have a height to support the bowls 18 but keeping them at floor level. In other embodiments, the legs 26 can have a height to raise the bowls 18 off the floor, depending on the needs of the user, as some pets, especially larger dogs, eat standing up and it may be easier with a bowl that is raised from about 4 to 10 inches off the floor. Either way, the extension rod 12 and handle 14 can be used to raise and lower the pet bowls 18 to allow access without the need for bending over.

The pet feeder can be made of various materials. Typically, the bowls 18 can be made of stainless steel, which can allow for easy washing, including washing in a dishwasher. In other embodiments, the bowls 18 can be made of plastic, composite, or any food-safe material. The bowl frame 22, legs 26, mid bar 28 and rod bracket 20 can be made of any material of suitable strength. Typically, these materials are selected so that splashed water does not cause rusting or damage. For example, these materials can include stainless steel, aluminum, plastic, composite, or the like. The extension rod 12 and handle 14 can be made from steel, plastic, composite, aluminum, or the like. The above describes exemplary materials for the construction of the pet feeder of the present invention, and such a list is not meant to limit the selection of materials for manufacture.

The pet feeder can be used to feed various pets and animals, including dogs, cats, ferrets, and the like.

It should be understood, of course, that the foregoing relates to exemplary embodiments of the invention and that modifications may be made without departing from the spirit and scope of the invention as set forth in the following claims.

What is claimed is:

1. A pet feeder comprising:
a bowl frame adapted to support one or more bowls;
an extension rod extending upward from the bowl frame; and
a handle disposed on an end of the extension rod.

2. The pet feeder of claim 1, wherein the bowl frame is configured to support two bowls adjacent to each other.

3. The pet feeder of claim 2, further comprising a mid bar connecting opposite sides of a mid-section of the bowl frame, the mid bar further supporting the bowls.

4. The pet feeder of claim 1, further comprising legs extending downward from the bowl frame.

5. The pet feeder of claim 1, further comprising non-slip feet disposed on ends of the legs.

6. The pet feeder of claim 1, wherein the bowl frame has a shape matching at least a portion of the shape of the bowl, wherein a lip on the bowl rests on the bowl frame.

7. A pet feeder comprising:
a bowl frame adapted to support two bowls therewithin;
a mid bar connecting opposite sides of a mid-section of the bowl frame, the mid bar further supporting the bowls;
legs extending downward from the bowl frame;
an extension rod extending upward from the bowl frame; and
a handle disposed on an end of the extension rod.

8. The pet feeder of claim 7, further comprising non-slip feet disposed on ends of the legs.

9. The pet feeder of claim 7, wherein the bowl frame has a shape matching at least a portion of the shape of the bowls, wherein a lip on the bowls rests on the bowl frame.

10. The pet feeder of claim 9, wherein the bowl frame has an oval shape adapted to support round bowls.
